(19) United States
(12) Patent Application Publication
(10) Pub. No.: US 2014/0087204 A1
(43) Pub. Date: Mar. 27, 2014

(54) TOOL MARKING STRUCTURE AND A FORMING METHOD THEREOF

(71) Applicant: Leo Shih, Taichung (TW)

(72) Inventor: Leo Shih, Taichung (TW)

(21) Appl. No.: 13/626,797

(22) Filed: Sep. 25, 2012

(51) Int. Cl. C25D 5/02; B32B 15/01

(52) U.S. Cl. 428/601; 205/118

(57) ABSTRACT

A method for forming a tool marking structure contains: a first plating means used on a surface of a tool so as to form a first plating layer; a coloring means applied to print a marking area with a first color layer on the first plating layer and to have the first plating layer on a bottom end of the marking area; a carving means served to eliminate a part of the first color layer of the marking area so that the marking area has a marking portion and a contrast portion formed therein; a second plating means provided to form a second plating layer on the surface of the tool and the contrast portion of the marking area.

### FIELD OF THE INVENTION

The present invention relates to a method of forming a tool marking structure which allows providing an excellent distinguished effect and an anti-rust purpose even though the second color layer of the marked portion is worn.

### BACKGROUND OF THE INVENTION

As shown in FIG. 1, a tool marking structure formed by a conventional forming method contains: a tool 10 electroplated so as to form a plating layer 11, patterns 12 printed on a surface of the tool 10 in a color. However, the patterns 12 is worn after a long period of using time, and the plating layer 11 shows another color, thus the patterns 12 cannot be distinguished clearly.

Referring further to FIG. 2, a tool 20 is imprinted so that recessed patterns 21 formed on the tool, and a color layer is printed on the recessed patterns 21, thereafter the tool 20 is electroplated so that the surface of the tool outsides the patterns 21 has a plating layer. But in the plating process, the color layer does not have a plating layer on a bottom end or an upper end thereof, so when the color layer is worn, the patterns become rusty.

With reference to FIG. 3, a tool 30 is electroplated so that a plating layer forms on the tool 30, and then the tool 30 is imprinted so that recessed patterns 32 formed thereon, and then a color layer is printed on the recessed patterns 32. Nevertheless, the color of the plating layer of the recessed patterns 32 are the same as that of the plating layer of the tool, hence the recessed patterns 32 cannot be viewed clearly.

The present invention has arisen to mitigate and/or obviate the afore-described disadvantages.

### SUMMARY OF THE INVENTION

The primary object of the present invention is to provide a method of forming a tool marking structure which allows providing an excellent distinguished effect even though the second color layer of the marked portion is worn.

Another object of the present invention is to provide a method of forming a tool marking structure which allows providing an anti-rust purpose even though the second color layer of the marked portion is worn.

To obtain the above objective, a method for forming a tool marking structure provided by the present invention contains:

a first plating means used on a surface of a tool so as to form a first plating layer; a coloring means applied to print a marking area with a first color layer on the first plating layer and to have the first plating layer on a bottom end of the marking area;

a carving means served to eliminate a part of the first color layer of the marking area so that the marking area has a marking portion and a contrast portion formed therein;

a second plating means provided to form a second plating layer on the surface of the tool and the contrast portion of the marking area.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional method of forming a tool marking structure.

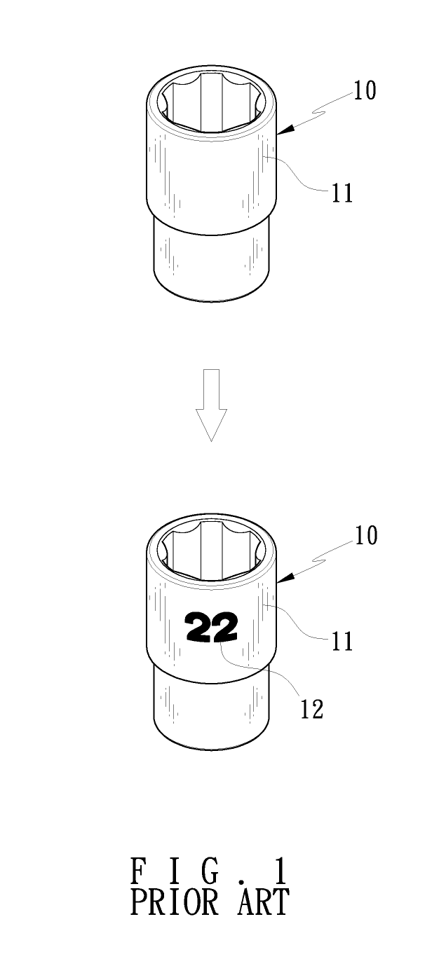

FIG. 2 is a perspective view of another conventional method of forming a tool marking structure.

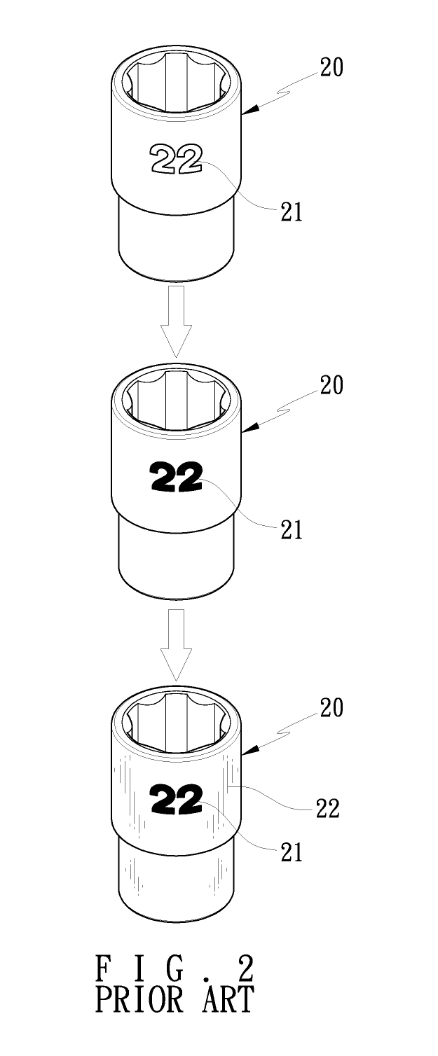

FIG. 3 is another perspective view of another conventional method of forming a tool marking structure

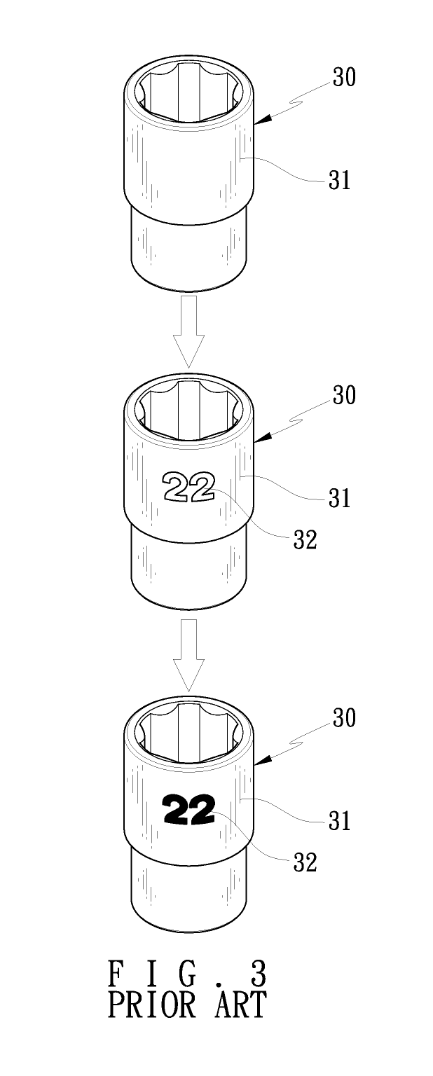

FIG. 4 is a flow chart of a method of forming a tool marking structure according to a first embodiment of the present invention.

FIG. 5 is a perspective view showing a tool marking structure according to the first embodiment of the present invention.

FIG. 6 is a perspective view showing a tool marking structure according to a second embodiment of the present invention.

### DETAILED DESCRIPTION OF THE PREFERRED EMBODIMENTS

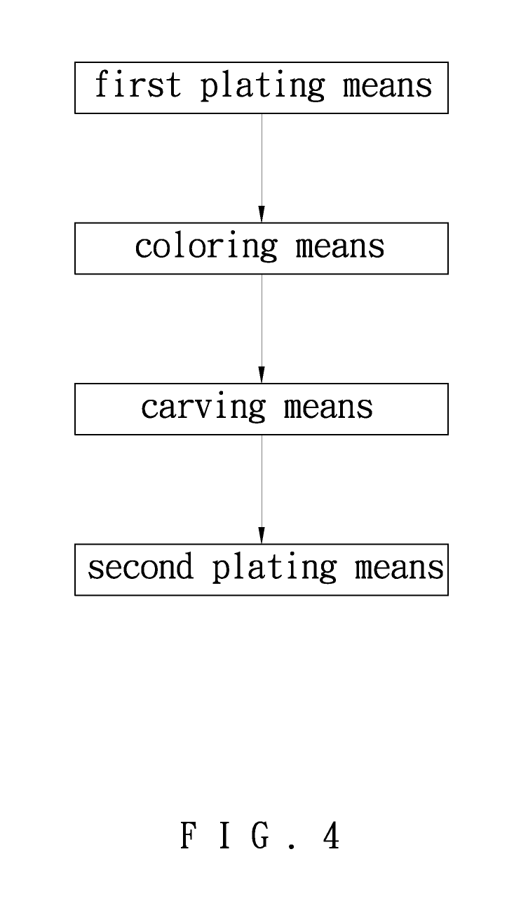

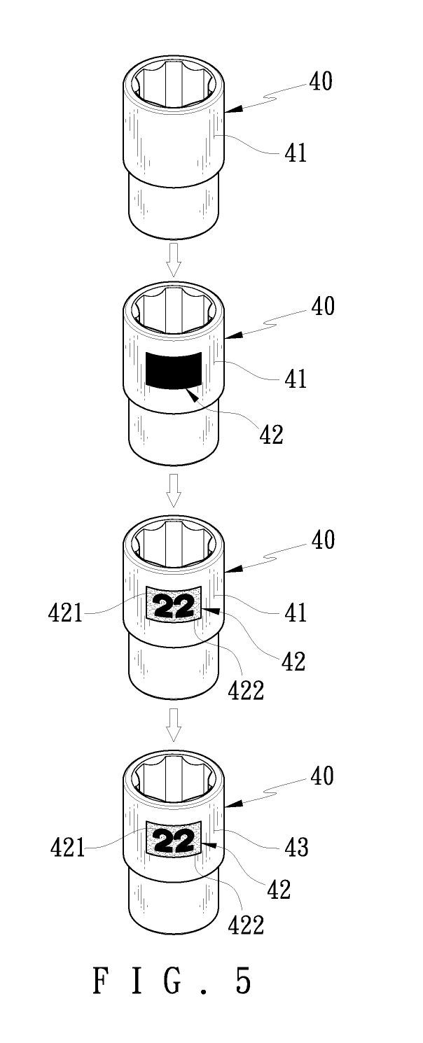

With reference to FIGS. 4 and 5, a method of forming a tool marking structure, such as a sleeve tool, according to a first embodiment of the present invention comprises: a first plating means used on a surface of a tool 40 so as to form a first plating layer 41. In this embodiment, the first plating means is copper plating on the surface of the tool 40 so as to form a copper plating layer. Thereafter, a coloring means is applied to print a marking area 42 with a first color layer on the first plating layer 41 and to have the first plating layer 41 on a bottom end of the marking area 42, and a carving means is served to eliminate a part of the first color layer of the marking area 42 so that the marking area 42 has a marking portion 421 and a contrast portion 422 formed therein. In this embodiment, the carving means includes eliminating the first color layer besides the marking portion 421 of the marking area 42 so that the marked portion 421 with patterns marked by a second color layer forms in the marking area 42, and the contrast portion 422 has a non-smooth bright surface in a third color. Finally, a second plating means is provided to form a second plating layer 43 on the surface of the tool and the contrast portion 422 of the marking area 42. In this embodiment, the second plating means will not generate an electroplating reaction because the marked portion 421 contains the second color layer, and since the contrast portion 422 does not have the first color layer which is eliminated by ways of the carving means, the surface of the tool 40 still has the first plating layer 41. Accordingly, the second plating means includes a nickel plating treatment or a chrome plating treatment on the surface of the tool 40 and the contrast portion 422 of the marking area 42, such that the first plating layer 41 of the tool 40 is electroplated the second plating layer 43, and the contrast portion 422 is electroplated the second plating layer 43 as well so that the surface of the tool 40 and the contrast portion 422 form a colorful nickel plating layer or a colorful chrome plating layer different from a fourth color layer of the first plating layer 41. Because the surface of the tool 41 has the second plating layer 43 which has a smoothly bright surface in a fifth color, the contrast portion 422 has the non-smooth bright surface of the second plating layer 43 in a third color, and the marked portion 421 has the patterns marked by the second color layer, the surface of the tool, the contrast portion 422, and the marked portion 421 form three different colors, thus obtaining an easy distinguished purpose. Preferably, when the tool is used for a long time to wear the second color layer of the marked portion 421, due to the second color layer of the marked portion 421 has the first plating layer 41, the marked portion 421 will not get rusty. In addition, since the contrast portion 422 is formed between the marked portion 421 and the surface of the tool, and the first plating layer 41 of the marked portion 421 has the fourth color different from the surface of the tool and the fifth color of the second plating layer 43, thus the patterns of the marked portion 421 is distinguished clearly.

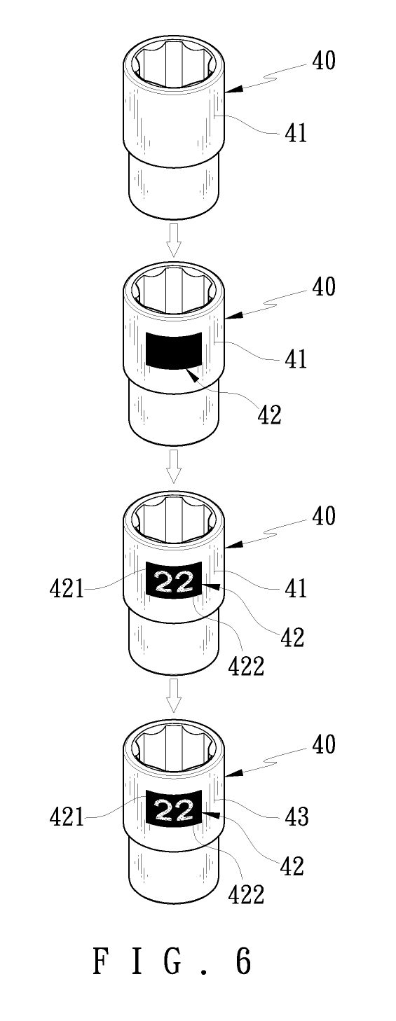

With reference to FIGS. 4 and 6, a method of forming a tool marking structure according to a second embodiment of the present invention comprises: a first plating means used on a surface of a tool 40 so as to form a first plating layer 41. In this embodiment, the first plating means is copper plating on the surface of the tool 40 so as to form a copper plating layer. Thereafter, a coloring means is applied to print a marking area 42 with a first color layer on the first plating layer 41 and to have the first plating layer 41 on a bottom end of the marking area 42, and a carving means is served to eliminate a part of the first color layer of the marking area 42 so that the marking area 42 has a marking portion 421 and a contrast portion 422 formed therein. In this embodiment, the carving means includes eliminating the first color layer insides the marking portion 421 of the marking area 42 so that the marked portion 421 with non-smooth bright patterns marked by a second color layer forms in the marking area 42, and the contrast portion 422 has a third color layer. Finally, a second plating means is provided to form a second plating layer 43 on the surface of the tool and the contrast portion 422 of the marking area 42. In this embodiment, the second plating means will not generate an electroplating reaction because the contrast portion 422 contains the third color layer, and since the marking portion 421 does not have the first color layer which is eliminated by ways of the carving means, the surface of the tool 40 still has the first plating layer 41. Accordingly, the second plating means includes a nickel plating treatment or a chrome plating treatment on the surface of the tool 40 and the marked portion 421 of the marking area 42, such that the first plating layer 41 of the tool 40 is electroplated the second plating layer 43, and the marked portion 421 is electroplated the second plating layer 43 as well so that the surface of the tool 40 and the marked portion 421 form a colorful nickel plating layer or a colorful chrome plating layer different from a fourth color layer of the first plating layer 41. Because the surface of the tool 41 has the second plating layer 43 which has a smoothly bright surface in a fifth color, the contrast portion 422 has the third color layer, and the marked portion 421 has the non-smooth bright surface of the second plating layer 43 in the fifth color, the marked portion 421 has the patterns marked by the second color layer, the surface of the tool, the contrast portion 422, and the marked portion 421 form three different colors, thus obtaining an easy distinguished purpose. Preferably, when the tool is used for a long time to wear the third color layer of the contrast portion 422, due to the third color layer of the contrast portion 422 has the first plating layer 41 defined on a bottom end thereof, the contrast portion 422 will not get rusty. In addition, when the third color layer of the contrast portion 422 is worn, since the first plating layer 41 of the contrast portion 422 has the fourth color different from the fifth color of the second plating layer 43, hence the contrast portion 422 is defined between the marked portion 421 and the surface of the tool, so that the patterns of the marked portion 421 is distinguished clearly.

Thereby, the method of forming the tool marking structure of the present invention allows providing an excellent distinguished effect and an anti-rust purpose even though the second color layer of the marked portion 421 is worn.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A tool marking structure comprising:
a marking area defined on a surface of a tool, a second plating layer defined on the surface of the tool besides the marking area, and the marking area having a marking portion and a contrast portion, the marked portion with patterns marked by a second color layer forming in the marking area, the second color layer of the marked portion having a first plating layer, and the contrast portion having a second plating layer being a non-smooth bright surface.

2. The tool marking structure as claimed in claim 1, wherein the second plating layer has the first plating layer formed on a bottom end thereof.

3. The tool marking structure as claimed in claim 1, wherein the first plating layer is a copper plating layer, and the second plating layer is a colorful nickel plating layer or a colorful chrome plating layer different from the first plating layer.

4. A tool marking structure comprising:
a marking area defined on a surface of a tool, a second plating layer defined on the surface of the tool besides the marking area, and the marking area having a marking portion and a contrast portion, the marked portion being a second plating layer having a non-smooth bright surface and having patterns marked by a second color layer, the contrast portion being a third color layer having a first plating layer formed on a bottom end of the third color layer.

5. The tool marking structure as claimed in claim 4, wherein the second plating layer has the first plating layer formed on a bottom end thereof.

6. The tool marking structure as claimed in claim 4, wherein the first plating layer is a copper plating layer, and the second plating layer is a colorful nickel plating layer or a colorful chrome plating layer different from the first plating layer.

7. A method for forming a tool marking structure comprises:
a first plating means used on a surface of a tool so as to form a first plating layer;
a coloring means applied to print a marking area with a first color layer on the first plating layer and to have the first plating layer on a bottom end of the marking area;
a carving means served to eliminate a part of the first color layer of the marking area so that the marking area has a marking portion and a contrast portion formed therein;
a second plating means provided to form a second plating layer on the surface of the tool and the contrast portion of the marking area.

8. The method for forming the tool marking structure as claimed in claim 7, wherein the first plating means is copper plating on the surface of the tool so as to form a copper plating layer, the second plating means includes a nickel plating treatment or a chrome plating treatment on the surface of the tool and the contrast portion of the marking area, such that the surface of the tool and the contrast portion form a colorful nickel plating layer or a colorful chrome plating layer different from a fourth color layer of the first plating layer.

9. The method for forming the tool marking structure as claimed in claim 7, wherein the carving means includes eliminating the first color layer besides the marking portion of the marking area so that the marked portion with patterns marked by a second color layer forms in the marking area, and the contrast portion has a non-smooth bright surface in a third color.

10. The method for forming the tool marking structure as claimed in claim 7, wherein the carving means includes eliminating the first color layer insides the marking portion of the marking area so that the marked portion with non-smooth bright patterns marked by a second color layer forms in the marking area, and the contrast portion has a third color layer.
